(19) United States
(12) Patent Application Publication
(10) Pub. No.: US 2003/0121036 A1
(43) Pub. Date: Jun. 26, 2003

(54) CATV messaging alert system

(75) Inventors: Howard C. Lock, Peshtigo, WI (US); Rick A. Pecore, Manitowoc, WI (US); James Todd Olejniczak, Appleton, WI (US)

Correspondence Address: WILHELM LAW SERVICE, S.C., 100 W LAWRENCE ST, THIRD FLOOR, APPLETON, WI, 54911

(73) Assignee: Howard C. Lock, Peshtigo, WI

(21) Appl. No.: 10/301,405

(22) Filed: Nov. 21, 2002

Related U.S. Application Data
(60) Provisional application No. 60/334,812, filed on Dec. 3, 2001.

(51) Int. Cl. H04N 7/025; H04N 7/10

(52) U.S. Cl. 725/33; 725/32

(57) ABSTRACT

This invention relates generally to use of standard video scan lines of commercial television programming in a cable television system for transmitting alerting and other messaging information, to an alert receiver unit at an end user's address. The alert receiver unit operates completely independently of any television set at the end user's address, other than to send the CATV signal from the alert receiver unit to the television set. The subscriber or other user can send certain pre-selected signals to the operator of the cable TV system, to another subscriber/user, or to another recipient designated by the operator of the cable TV system. The invention relates especially to emergency notification systems and to systems for communicating emergency messages to subscribers to cable television distribution networks, as well as to non-subscribers.

### BACKGROUND

This invention relates generally to use of standard commercial television and television distributive cable systems for alerting, messaging, and other announcements of events of an urgent, or otherwise important, nature, to subscribers to the cable TV system, as well as to non-subscribers who choose to avail themselves of the alert system. The invention also relates to the subscriber or other user sending certain pre-selected signals to the operator of the cable TV system, to another subscriber/user, or to another recipient designated by the operator of the cable TV system. More particularly, the invention relates to emergency notification systems and, more particularly, to systems for communicating emergency messages to subscribers to cable television distribution networks, as well as to non-subscribers.

The need to communicate limited content messages for warning and mobilization purposes in emergency situations, for government agencies seeking assistance, or for an alert recipient seeking assistance, is growing. Sirens and similar conventional warning systems are becoming antiquated and relatively less effective for various technical and other reasons. Such conventional warning systems are often limited by dependence on e.g. hard-wired AC power, vulnerability to weather and natural disasters, human errors and delays. Cable TV-based emergency alert systems utilizing signals from the National Emergency Alert System, referred to as EAS, have heretofore suffered from high cost, the need to integrate messaging electronics into either the TV set or a cable box, and the fact that the TV set must be provided with electrical power and the set must be turned on when the alarm is issued in order for a subscriber to be alerted.

### SUMMARY

This invention uses the current built-in infrastructure of analog or digital TV signals, and utilizes the wide general distribution of such signals to the general public.

This invention complements and enhances the National Emergency Alert System by quickly making the alerts known to a much greater number of people.

The invention is an alert system, and methods of distributing alert signals. The invention equips each cable TV subscriber in a system with an emergency message alert receiver unit connected to the CATV distribution cables. Non-subscribers can also optionally be provided with receiver units, although CATV cable must be installed to the non-subscriber's situs. The alert receiver unit is operable by issuance of a plurality of pulses from a head end signal generator at the head end of the cable system, which causes the alert receiver unit to issue visual and/or audible signals to alert the recipient to the existence of e.g. an emergency situation and to the basis of the nature of the emergency. The subscriber is advised, by previous communication, to turn on the TV set to a designated channel to receive specific emergency message communication. If power to the TV set is not available, the user has the option of calling local authorities in order to receive the alert message.

Optionally, the alert receiver unit includes a transmitter, by which the recipient/subscriber or the alert receiver unit itself can send certain predetermined types of messages to the cable system operator and/or, by set-up of the specific receiver unit, to another addressee in the alert system operator's database of addressees. The alert receiver unit can, for example, automatically return a signal to confirm that the alert receiver unit is operating properly.

The invention includes a sending unit, namely a head end signal generator, preferably at the head end of the cable system. The sending unit can be operable to direct messages to specific groups, within the overall group of potential recipients of messages and who are located in the service area of the cable TV system, including non-subscribers to the cable TV system but who are recipients connected to the alert system of the invention.

The invention further includes the alert receiver unit which, in the preferred embodiment, after receiving an alert communication, issues visual, audible, vibrational, and/or other warning signals from the alert receiver unit, not from the recipient's television set, which warning signals can be detected by the human senses.

One aspect of the invention is to provide an addressable alert receiver unit adapted to be connected to CATV coaxial cable. In accordance with a preferred embodiment the receiver unit is positioned electrically between the cable TV outlet connection in the home, and the television set, and between the cable TV outlet connection and any cable box associated with the TV set. Thus, the CATV signal, which includes the alert signal, reaches the alert receiver unit before being passed in series to either the cable box or the television set.

In accord with another aspect of the invention the alert receiver unit, and the alert system, functions to deliver the alert signal independent of whether the television set is powered on, and whether electric utility network power is available and functioning at the situs of the television set, or whether the cable distribution network is operable at the time the alert is being sent.

A related aspect of the invention is that the alert receiver unit can alert the subscriber independent of whether the subscriber is watching television; nor does the subscriber have to be in the same room as the television set; nor does the television set have to be tuned to a particular channel. It is further feasible for a subscriber to possess one or more remote alert receiver units, and to locate such remote alert receiver units throughout a residence or other building structure, or in the vicinity thereof.

In accord with a still further aspect of the invention, an alert receiver unit of the invention can be attached to a rear surface of a television set, or to a wall behind the television set, or other place not readily visible, and can be provided with an elongate signal display device which carries an initial alerting visual signal indicating that an alert message has been received. The visual alert unit can be a red LED device or a white light transmitted through a fiber optic cable, or any other readily visible light source at the end of such elongate signal display.

In accord with a still further aspect of the invention, an alert warning can be provided to all subscribers who possess alert receiver units, or only to selected persons, for example, volunteer fire department members, policemen, school executives, etc. Also, an additional optional remote alert unit can be provided to receive an alert at any point within two hundred feet of the alert receiver unit.

In accord with still further aspects of the invention, the subscriber or other user is advised that, when the subscriber or other user receives an alert message, the user should turn on the television set to a selected channel, e.g., channel 3 or other designated emergency message channel, to receive specific information relating to the emergency message.

In accord with still further aspects of the invention, the alert receiver unit can be provided with circuitry, including a timer, which causes the alert receiver unit to continue to broadcast and/or display or otherwise emit, the alert signal, for a pre-determined set period of time after receipt, from the cable system head end, of an alert,message, e.g., 24 hours. The alert receiver unit can provide a visual alert signal by e.g. an LED light, or any other light-emitting source of sufficient intensity to be expected to attract a subscriber's attention, and which light source remains illuminated during the pre-set period of time.

An audible tone can be generated either concurrently, or in the alternative, which audible tone is either broadcast continuously or at set intervals. The visual and audible signals can continue until deliberately reset by the subscriber or can be pre-set to continue for a specified limited period of time or can be extinguished as desired by command from the head end, e.g. from the head end signal generator. The time pre-set for e.g. the audible alarm can be different from the time pre-set for the visual alarm.

In accord with a still further aspect of the invention, the information from which the emergency message is derived can originate from a variety of source such as the CATV head end office, a police station, a fire station or a national emergency alert facility such as FEMA. The cable TV system operator receives the emergency or other alert message from the originating source, inputs the alert message into the head end signal generator, either manually; or automatically using appropriate coding software to suitably identify the nature of the signal being sent, and thereby coding for selection of appropriate addresses, and sends the alert message through the cable TV system, targeting desired addressees.

### BRIEF DESCRIPTION OF THE DRAWINGS

FIG. 1 is a flow chart, partial schematic illustrating signal flow in a first embodiment of a head end generator of the invention.

FIG. 2 is a flow chart, partial schematic illustrating signal flow in a second embodiment of a head end generator of the invention.

FIG. 3 is a flow chart, partial schematic illustrating signal flow in an in-line alert receiver unit of the invention.

FIG. 4 is a top view of an addressable alert receiver unit in accord with the invention, and as illustrated in FIG. 3.

FIG. 5 is a bottom view of the addressable alert receiver unit of FIG. 4.

FIG. 6 is an overall flow chart of the messaging alert system of the invention.

The invention is not limited in its application to the details of construction or the arrangement of the components set forth in the following description or illustrated in the drawings. The invention is capable of other embodiments and of being practiced or carried out in various other ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

Emergency messaging alert systems of the invention in general include a head end signal generator “A” at the head end of the cable television (CATV) system, and an alert receiver unit “B” at the receiving terminus of each subscriber or other user.

The head end signal generator generates the alert signal based on input from any of a variety of sources, selects from a known database of potential recipients those subscribers or users or groups of subscribers or users, for whom the alert signal is appropriate, and transmits the alert signal throughout the system, along with suitable identification and other address codes which identify the group or groups of subscribers/users for whom the alert signal is intended, or by whom the alert signal can be appropriately received.

When the alert signal arrives at a given alert receiver unit in the CATV system, the alert receiver unit examines, monitors the signal for the identification code. If the identification code in the alert signal matches a code pre-set in the alert receiver unit, the alert receiver receives the message portion of the signal and the alert receiver unit outputs a corresponding audible, visible, or like signal. If the identification code in the alert signal does not match a code pre-set in the respective alert receiver unit, the respective alert receiver unit ignores the alert signal.

In practice, the subject invention inserts a High Speed Data Line (HSDL) burst into the video line scan of an NTSC, EIA RS-170, signal at the head end of the cable system, namely at the CATV station transmitter, as replacement for, namely in place of, the program information which is normally carried in the respective scan lines. Thus, the alert signal is, imposed on the selected scan lines of a selected channel, thereby deleting the program information which would otherwise normally be transmitted on those scan lines, on that channel. But only one channel of programming need be so affected.

The speed, size range, and location within the precise timing of the NTSC signal allows for various addressing and command functions. This addressing and command information can be transmitted on the viewable scan lines with minimum disturbance in the viewable picture of the normal program information on the respective channel.

The NTSC (RS-170) signal normally used in commercial television program transmissions represents 525 horizontal line scans of video information, as well as the audio portion of the signal. Of the 525 line scans, only 484 lines are visible. In the current state of the art, the non-viewable portion of the NTSC signal, namely the non-viewable lines, is known as the “vertical blanking” portion of the signal. The vertical blanking portions of the signal conventionally may contain picture reference, time clock, closed caption and Videotex/Teletext services, and other related information.

In this invention, the alert signal can be carried in the non-visible off-screen area of the video portion of the signal, and transmits address, command and data security information on one or more horizontal scan lines, and typically carries the actual alert information on an additional horizontal scan line. The HSDL can be used in the off-screen area (non-visible) or in the on-screen visible portion of the signal. Where the non-visible lines are used, and where the capacity required to transmit the alert information is greater than the otherwise-unused capacity of the non-visible lines, the top and/or bottom portions of the viewable screen are used next in accord with system requirements, in which instance the more central viewing zone of the video signal is free of any address and command video signals, and any alert information signals, relating to the alert system of the invention. Nevertheless, where viewable scan lines are used, the fraction of the 484 scan lines which are viewable on each scan, which are so replaced, is so small that the visible perception of picture quality change is generally imperceptible to the casual viewer.

The Head End Unit

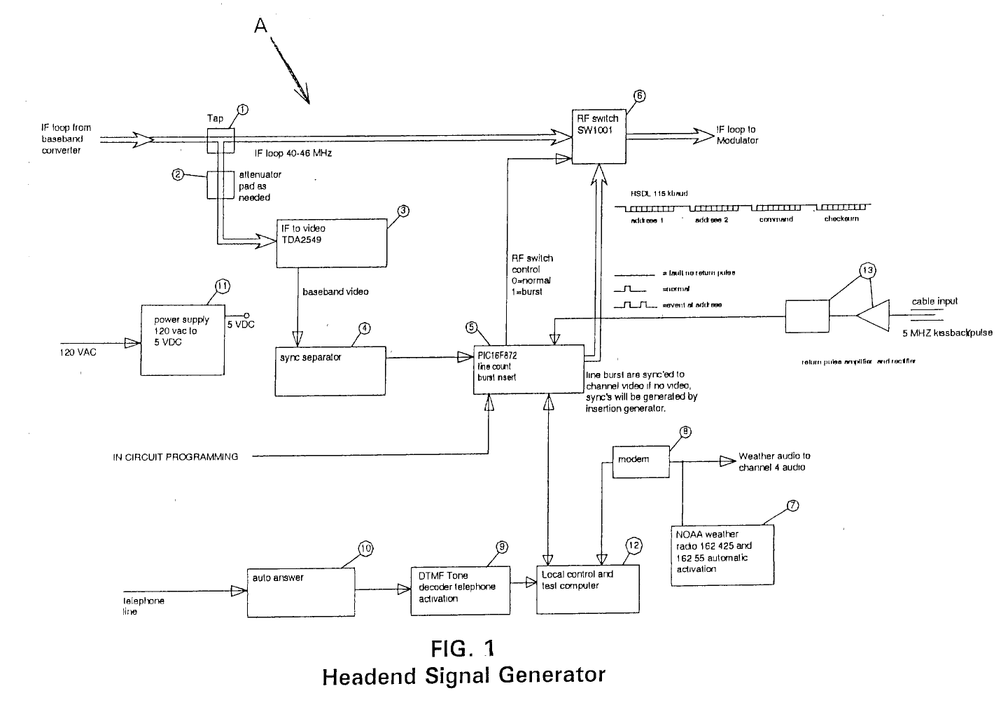

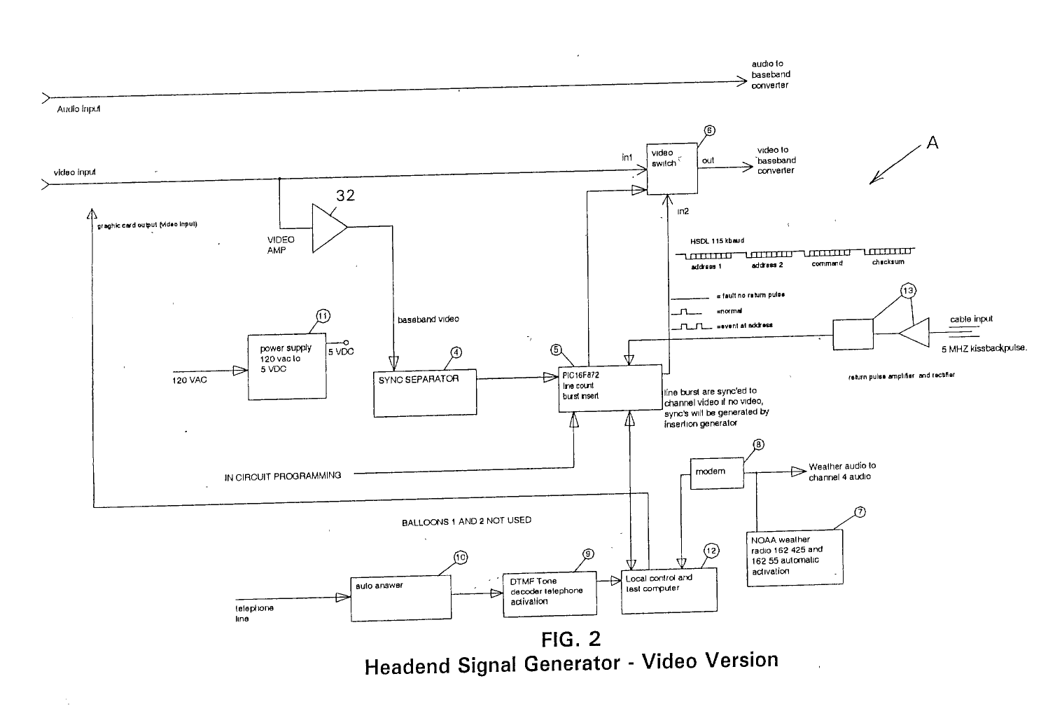

FIG. 1 illustrates an embodiment of the invention wherein the head end signal generator replaces the coaxial cable which extends between the baseband-to-IF converter and the channel modulator. Such replacement can also be done at the video input to the baseband converter, as illustrated in FIG. 2, in which case the audio signal remains unbroken during the HSDL burst. FIGS. 1 and 2 illustrate the same general structure of the head end signal generator except for the source of the video. FIG. 1 receives the video input from the IF loop. By contrast, FIG. 2 receives the video input from the baseband video, or graphic card output. The description starting from and beyond the sync separator, which is designated 4, applies to the configurations of both FIGS. 1 and 2.

Returning now specifically to FIG. 1, a tap 1 in the IF loop transfers part of the RF signal to line attenuator pad 2, which reduces the level of the IF loop to match the requirements of an IF-to-video converter 3. Full video is captured by the IF-to-video converter. IF-to-video converter 4 passes the signal to sync separator 4. Sync separator 4 extracts timing information, including vertical and horizontal sync pulses, from the video signal. The vertical sync pulses are measured by microprocessor 5, to ensure that video is present and that the timing is correct. If no video is present, and as a back-up option, the microprocessor can generate the required sync pulses and HSDL burst while also providing the correct timing.

Referring to FIG. 2, video amplifier 32 samples the baseband video or graphic card output signal and provides the output signal to Sync separator 4 which provides signal output to microprocessor 5.

Microprocessor 5 is the central computer controller in the head end generator in both of FIGS. 1 and 2. An in-circuit programming input to microprocessor 5 is used to install and up-date the operating program of the head end generator. A suitable such microprocessor is a PIC 16F872 microprocessor available from Microchip Technology Inc., Chandler, Ariz.

Microprocessor 5 times the pulse length, counts the scan lines and determines at which point the HSDL burst is to be inserted into the video scan. The head end signal generator receives alert messages from a variety of sources, including from an NOAA weather or EAS radio signal 7 e.g. through a modem 8. The signal can be an emergency signal generated by local government agency such as the fire department or police department, or can be feed from any level of government such as an Amber alert. Such governmental feeds are typically received at an auto answer telephone line 10 and processed through a DTMF tone decoder 9 to local computer 12.

In the alternative, the alert signal can be generated by the cable system operator such as to alert subscribers that the hard-wired cable TV system will be out of service for a planned period.

The alert system of the invention can be structured such that the cable operator manually intercepts all potential alert messages and applies human judgement or other criteria in determining whether the alert signal is to be disseminated, and/or for determining the appropriate addressees or groups of addressees, for such alert signal. In such cases, manual entry of certain commands, such as keyboard entry, is typically desired as a step in implementing dissemination of the information.

In general, the incoming signal is received into the head end signal generator at a local control and test computer 12. The signal can enter the head end generator from, for example and without limitation, a NOAA or EAS radio signal through modem 8. In addition, or in the alternative, a signal can enter the system through a telephone line, such as a data signal, through DTMF tone decoder 9, or the like. Further, the signal can enter the system by e.g. manual input through a keyboard or like device being operated by the CATV system operator.

Whatever the source of the input signal, the input signal is first directed to auxiliary computer 12 which contains the database of current subscribers and other users of the alert system. The database in computer 12 includes identifying information about each such user, such as address, and e.g. by code the types of signals which are to be activated at the respective addresses. If desired, the functions of microprocessor 5 and auxiliary computer 12 can be combined into a single computer and/or housed in a single housing.

When a bona fide alert signal is received, from whatever source, computer 12 determines the proper alert identification code to be associated with the alert signal, thus identifying the nature of the alert, and the corresponding type of e.g. threat involved. Computer 12 then queries its database, and identifies those entries/addresses in the database which are associated with the alert/threat type code which has been associated with the alert signal received. Computer 12 then outputs a data stream to microprocessor 5. The outputted data stream includes the alert signal, the identifying code of the alert signal, and the addresses of those users who are associated with that specific code in the database queried by computer 12.

Microprocessor 5 then generates a serial, asynchronous data stream of addresses and commands, with placement of the respective data stream into the video scan at the pre-determined scan lines, and outputs a switch command to RF switch 6, thereby activating switch 6 to receive data from microprocessor 5 and correspondingly transmits the signaling data stream into the appropriate video line scan or scans at switch 6.

Thus, the data transmitted from computer 12 to microprocessor 5 is used by microprocessor 5 to generate address, code, command, and alert signals which are distributed, as part of the video signal, so as to activate the intended alert receivers in the CATV system. As used herein with respect to the alert system, “CATV system” includes non-subscribers who can receive alert signals without direct connection to a system CATV coaxial cable, such as through an FM wireless transmission from the head end of the cable system.

Computer 12 and/or the database of information from which computer 12 draws, can be located at a location remote from the remaining elements of the head end signal generator, whereupon computer 12 and/or the database source is connected through, to microprocessor 5, using suitable communication links, whether hard wired or wireless, and employing appropriate communications hardware and software.

Item 13, is a 5 MHz kissback pulse amplifier and associated rectifier. This kissback circuit is connected to microprocessor 5 and receives, from the in-line alert receiver units, return acknowledgment pulses from the addressed inline alert receiver units in the destination users' homes or other facilities.

In the illustrated embodiments, power is supplied to head end signal generator “A” by a 120 VAC to 5 VDC power supply.

The level of addressing and commands are limited by the data speed used and the data length. In an exemplary system, two (2) 8-bit address bytes and (1)one 8 bit command byte are used. This gives 65536 possible addresses and 256 possible commands. The data rate is set at 1250 k baud. This allows 0.8 microsecond per bit. Allowing 10 bits per useful byte of information (8 date bits, 1 start bit, 1 stop bit) gives 8 microseconds per byte. Alerting time for global addressing, for example for alerts and special functions, is nearly instantaneous since a single address signal is used for all addresses. In most cases, addresses can be selected by groups of addressees, with each group being serviced by a single code. In such cases, the transmission time for sending the alert to all appropriate recipients is reduced in accord with the reduction in the number of address codes used in place of individual addresses which correspond with individual recipients.

A limited number of addresses or address codes can be used as universal or global addresses causing the alert signal to be sent to large numbers of users identified by such common characteristic, in which case, the kissback signal may be dispensed with. Examples of global addresses or address codes are the entire cable system, a delimited geographical area such as west of Main Street and North of Second Street. The national postal zip code system can be used as a basis for global addressing, or specific addressing. Similarly, the rural fire numbering system can be used as a basis for global addressing, or specific addressing. Also similarly, coordinates from a Global Positioning System can be used as an addressing basis.

The Alert Receiver

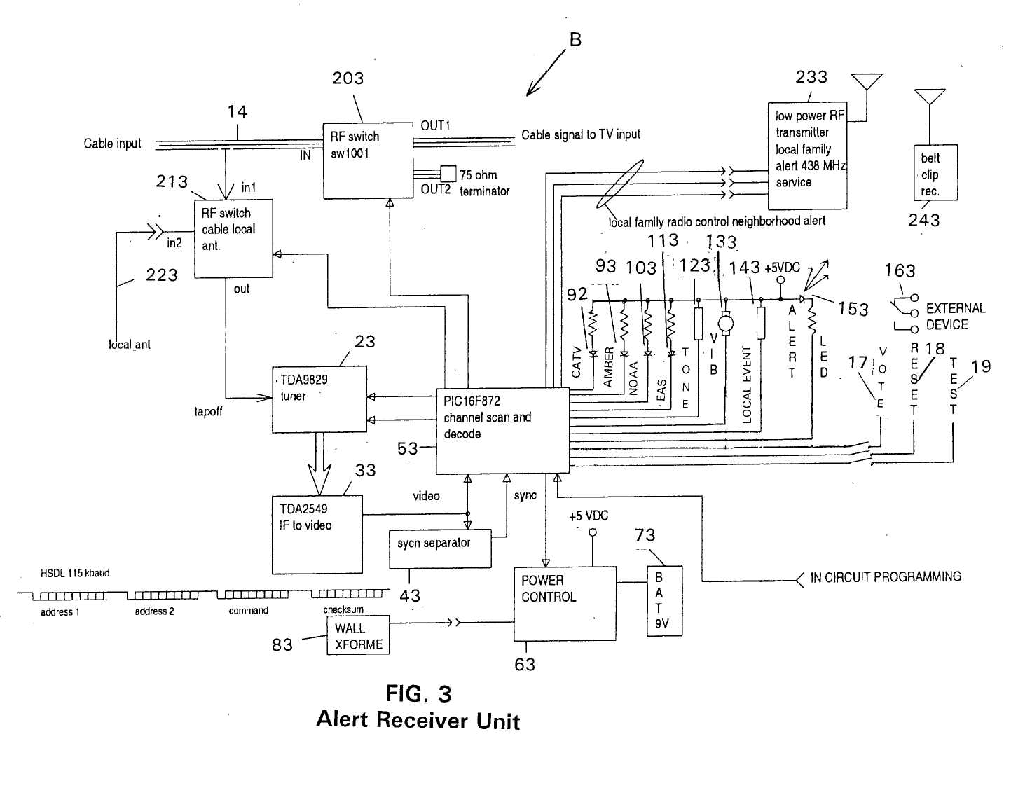

Referring to FIG. 3, alert receiver unit “B” is positioned at the situs of each address to be serviced by the alert system of the invention. Typically, the alert receiver unit is contained in a stand-alone housing, separate from a television set which may be co-located, with the alert receiver unit, in a building, out of the weather. The alert receiver unit is typically fastened to an interior wall of the building, or to the back of a customer's television set. In some cases, a convenient location is between the CATV wall terminal and the customer's television set. The CATV cable is fed from the CATV wall terminal to the alert receiver unit, and from the alert receiver unit in series to the television set or to a cable box.

Suitable provisions are made for feeding power up the cable to any needed local inline amplifier units.

Power for operation of the alert receiver unit is provided by a wall mounted transformer 83 shown in FIG. 3 and a suitable power cord which is plugged into a receptacle which is connected to the national electric power distribution system, namely to an electric utility power distribution network. Limited standby operating power is provided by a rechargeable 9 VDC battery 73, also shown in FIG. 3.

Still referring to FIG. 3, incoming coaxial cable 14 is tapped and thereby diverts a small portion of the cable signal to switching relay 213 which is normally closed from IN1 to out. Cable 14 also supplies RF switch 203 which generally feeds the cable signal on to the cable system subscribers, as well as to non-subscriber recipients of the alert system who may optionally be hard-wired into the CATV cable system, or who may receive alert signals only through the wireless FM transmission system antenna 223. Switch 203 is a switching relay like switch 213, with a normally-closed feed thru from IN to OUT1. Both switches 203 and 213 of FIG. 3 are controlled by microprocessor 53. A suitable such microprocessor is a PIC 16F872 microprocessor available from Microchip Technology Inc., Chandler, Ariz.

Switch 213 is used to switch the alert receiver unit “B” over to a local e.g. vhf antenna 223 for reception of a local, “all else has failed” signal from an e.g. area FM radio transmitter controlled by the cable operator from the head end of the cable system. This last chance radio signal is coded to force an alert onto the alert receiver unit, thereby to always alert the addressee to such events, irrespective of address commands at computer 12. Switch 213 e.g. is switched to the local antenna if the cable system is non-functional, namely is out of service, or if line power is lost at the alert receiver whereby power control 63 switches to battery 73 for back-power to power the alert receiver unit. Meantime, the head end signal generator can be broadcasting, over e.g. one or more conventional FM transmitters, the same alert information which is being transmitted over the CATV cable, thus to be received at antenna 223. Thus, if a recipient/addressee is unable to receive the alert signal through the CATV cable, the alert receiver unit can receive the corresponding signal through FM antenna 223.

Switch 203 operates as a service cut-off switch and can be used to disconnect cable service e.g. at customer request during long periods of absence and can be controlled by individual address and command from the cable system operator's home office.

A highly integrated “TV tuner on a chip” 23 is digitally controlled by microprocessor 53. Tuner 23 receives the RF signal from cable input 14 through switch 213. Tuner 23 converts the cable signal to IF level (40-47 MHz) for processing by IF-to-video converter 33. Tuner 23 and converter 33 can be combined into a single unit as desired. An exemplary such tuner 23 is sold by Philips Semiconductor, Eindhoven, The Netherlands, under the designation TDA9829.

Such 9829 tuner tunes all channels from channel 2 to channel 720, as well as receiving all commercially-broadcast FM frequencies. Thus, tuner 23 can receive and tune both the signal transmitted through the CATV cable network and the FM signal being transmitted by head end unit “A”. In addition, the exemplary 9829 tuner 23 tunes all signals in both the visible line scans and the non-visible line scans of the video signals representing the respective television channels.

The signal transmitted by head end unit “A” can be placed in any one or more of the lines of the line scan video signal. In some instances, the non-visible lines are available, and can be used, whereby there is no disruption at all, of the visible lines. In other instances, visible line scans are used; but since the quantity of program information which is pre-empted by the alert signal is so small, the degree of disruption of the picture display on the downstream television set is nominal, and is not detected by the casual viewer.

In either event, the alert signal transmitted by head end unit “A” replaces the regular programming signal in that portion of the one or more line scans which are occupied by the alert signal. Thus, if scan line 15 is used to transmit the alert signal, the programming signal which normally is transmitted in association with line 15 is deleted, is not available to the television tuner, and is replaced by the alert signal.

A typical alert signal transmission can include a start bit, followed by 8 bits of e.g. alert information, followed by a stop bit, thus to consume one byte. Such alert signal transmission is repeated until the full capacity of the given scan line is used. Accordingly, the alert signal is typically repeated 2-4 times on a given line scan, and preferably includes a checksum signal.

Sync separator 43 receives the video signal and forms the vertical sync pulse which is measured and counted by microprocessor 53. Microprocessor 53 also receives video feed directly from video converter 33.

Microprocessor 53 is the center of operations for the alert receiver unit. A suitable such microprocessor is the above Microchip Technology Inc. 16F872 reduced instruction set microprocessor operating at 20 MHz clock speed.

Microprocessor 53 receives the sync pulses, from sync separator 43, and the real-time video feed from video converter 33, and decodes the serial, asynchronous data which has been transmitted on the selected scan line of the video signal. Microprocessor 53 queries the address portion of the alert signal and, if the address matches an address set in the alert receiver unit “B”, processes the command portion of the alert signal. The alert receiver unit can be programmed to recognize and respond to any of a number of different address commands and/or codes. As appropriate, a kissback acknowledgment is implemented by placing e.g. a short 5 MHz return pulse on the cable. As illustrated in FIGS. 1 and 2, one pulse on the kissback return signal is normal and can be sent in all cases, with optional exception as desired, e.g. for special alert addresses and global addresses which go to more than one alert receiver unit. Two pulses are sent in the event of a special condition at the alert receiver unit, such as a high water alarm, a smoke alarm, a low temperature alarm, a medical alert, or the like, all of which special conditions can be programmed into alert receiver unit “B”, and wherein the alert receiver unit is connected to appropriate sensors in the vicinity of the respective alert receiver unit.

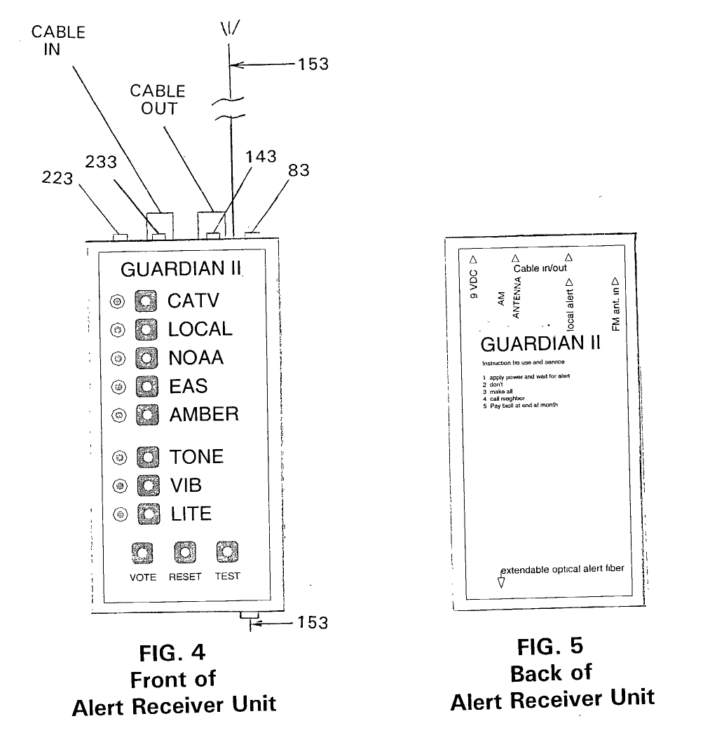

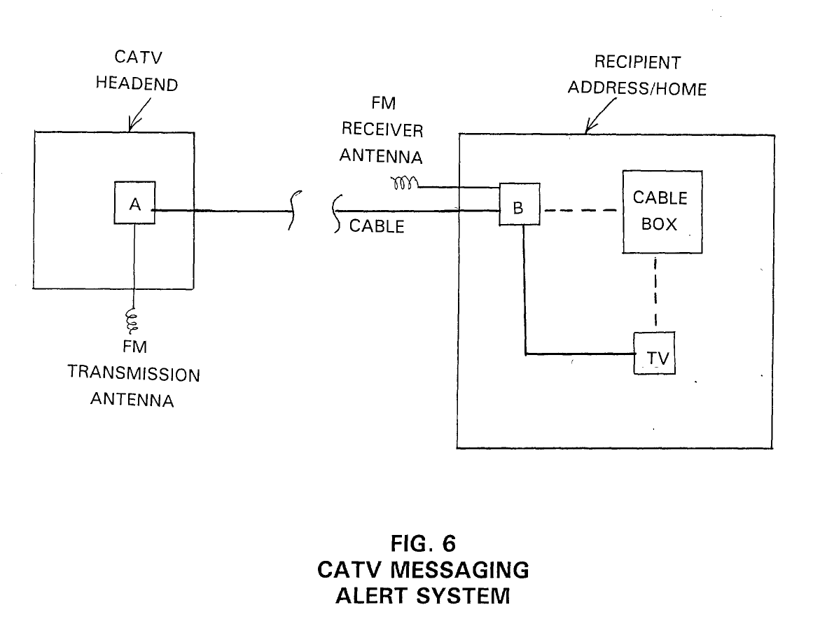

The primary purpose of the alert receiver unit, indeed of the alert system of the invention, is to receive emergency alert information at a collection site such as at the primary site of cable operations of a cable operator, and then to emit, and/or otherwise disseminate, one or more signals which carry the alert information, and which can be detected by the human senses. Referring to FIGS. 3 and 4, when such an alert signal is received, the appropriate LED or other light source 153 is activated e.g. by repeatedly blinking on and off or by steady illumination to indicate in general that an alert signal has been received. Vibrator 133 can be turned on.

An example alert unit “B” has three front panel switches and eight sets of switches and corresponding indicator lights. Local event switch and light 143 are used to indicate an event which has occurred at the situs of the alert receiver unit. Switch and light 123 are used to enable or disable a tone response to an alert signal. Switch and light 113 are used to indicate and control an EAS signal. Switch and light 93 are used to indicate and control an Amber alert signal. Switch and light 92 are used to indicate an alert signal sent by the CATV operator.

The three front panel switches 17, 18, 19 control vote signal in a first switch 17, reset function in a second switch 18, and test function in a third switch 19. Pressing and holding the reset switch, and pressing the test switch repeatedly, enables the user to activate or deactivate any of the eight switch/light sets, thus to select those alerts to which the alert receiver unit responds, and the mode or modes of the response. The selection depends on the number of times the test switch is depressed and the corresponding pressing of the respective ones of the eight switches associated with the switch/light sets. The “lite” LED responds only when the “test” switch is depressed, indicating that the receiver unit is functioning properly. Depressing the vote switch sends a single signal to the cable operator.

The vote switch can be used, for example, for feed-back communication from the alert system user to the cable operator. For example, the cable operator can place a message on the emergency channel indicating the significance of depressing the vote switch during a given time period and the message which will be so indicated. For example, the cable operator can broadcast a message on the emergency channel that depressing the vote switch during a first given time period expresses a “yes” vote on a posed question, and depressing the vote switch during a second given time period expresses a “no” vote on the posed question. Only one such response will be accepted from each alert receiver unit for each posed question. Such voting can be used, for example, for commercial purposes such as querying cable subscribers regarding service and pricing questions. Such voting can be used for other purposes as well, such as political polling, using e.g. the same timing considerations.

A separate switch, of course, can be provided for each function of the vote, reset, and test switches, with attendant likely increased cost and potentially reduced reliability.

The NOAA light and switch 113 is used to indicate a national weather alert. Alert LED 153 is an extra-bright LED coupled to a fiber optic cable which extends from the alert receiver unit “B”, by a distance of e.g. about 18 inches. Thus, the end of the fiber optic cable can be positioned so as to provide easily visible light indication to occupants of the room in which the alert receiver unit is housed. The fiber optic cable can be any desired length.

When an alert signal is received, the recipient can turn the signal off by pushing the reset button, having received (a) information that an alert has been received and (b) the general nature of the alert. When the alert signal is sent, the CATV operator typically adds further content in one or more of the regularly-transmitted television program channels. Such additional information may be transmitted in the normal video/audio scan lines, and/or can be added as a crawl at an edge of the viewable video window. The recipient has the option of viewing such additional message by tuning his/her television to the respective channel.

The alert receiver unit is capable of passing an alert signal to a local but displaced wireless receiver in the vicinity of the addressee situs. A low power e.g. AM transmitter 233 receives the alert signal from microprocessor 53, and optionally transmits the alert signal. Transmitter 233 can operate e.g. in one of the license-free frequency bands. The transmitter or transceiver is controlled by microprocessor 53. A remote e.g. battery powered radio receiver 243, tuned to an appropriate frequency, can receive the signal transmitted by transmitter 233 so long as the receiver is within range of the signal so transmitted. One or more such remote receivers can be placed in e.g. a patio or pool area, the garage, the basement, or the like, or can be mounted to a person's belt clip so as to warn a specific individual who is displaced from the alert receiver unit. For example, the person may be doing yard work, or may be moving about on a factory floor, or may be moving about in an office building.

When transmitter 233 and receiver 243 are both transceivers, two way communication can be achieved.

The head end generator can remain off-line, though powered up, until an alert signal is to be transmitted. Under such scenario, when an alert signal is to be transmitted, the head end generator comes on line, and the regular programming information for the selected channel is replaced by the alert signal on one or more of the regular scan lines of the video signal. The alert signal typically includes such information as identification code recognizable by the alert receiver units, address information, the alert information itself, as well as suitable start, stop, and like recognition codes. The so-compiled signal is then sent to e.g. the selected addresses, address groups, or address codes, with kissback acknowledgments as appropriate.

In other implementations of the invention, the head end generator is continuously on line, and sends a known identification signal, along with test data, with each set of scan lines transmitted as programming information on the selected channel, thereby regularly and repeatedly testing each alert receiver unit at the respective addresses for capability to perform the alert function as addressed. The head end generator may, or may not also look for the kissback acknowledgment from each alert receiver unit, indicating its functional condition depending on whether the kissback acknowledgment was requested in the signal sent from the head end signal generator. The kissback response is indicated in FIGS. 1 and 2 by a flat line representing a fault, namely no return signal; a single wave signal representing a normal response, and a double wave signal representing an event at the respective address such as a medical alert, smoke alarm, high water alarm, and the like. Where an alert receiver unit does not properly respond, or responds with an “event at address” signal, the head end generator, through computer 12, signals the respective response to the cable operator, whereupon the cable operator can then take the appropriate action.

While the alert receiver unit has been described as a separate stand-alone piece of equipment, the operating elements thereof can be resident on a single circuit board, which can be incorporated into a consumer's television set, whereupon the feed from the cable terminal on the interior wall of the building, which feeds directly or indirectly to the television set, can be plugged directly into the television set, whereupon the signal feeds through the receiver of the invention. The alert receiver unit, when housed in the television set housing, operates in the same manner as described herein, thereby to provide the same types of alert signals, except that such signals can be expressed through the television set as well as through conventionally-known external response devices. Separate audible tones and visual signals, as are displayed on the stand-alone unit, can be built into the television set response system, or a television outlet terminal can feed a stand-alone or associated external signaling device outside the main television cabinet.

The following elements illustrated in the drawings, and described hereinabove, have the following meanings. Designation numbers are shown with some elements.

Address 1—The lower half of a 16-bit address used to target a specific alert receiver unit or set of alert receiver units.

Address 2—The upper half of a 16-bit address used to target a specific alert receiver unit or set of alert receiver units.

Command—An 8-bit pattern which instructs a receiver to take a particular action.

Checksum—An 8-bit pattern used by the alert receiver unit to verify the integrity of an overall transmission.

IF Loop—Signal which contains the video signal on an intermediate frequency.

3—IF to video—tuner module which demodulates a video signal of an intermediate frequency.

3—TDA2549—Integrated component manufactured by Philips Semiconductor, Eindhoven, The Netherlands, and used to construct a video or similar tuner.

4—synch separator—A device which extracts timing information from a video signal. A common component which provides this function is a national Semiconductor LM1881.

5—PIC16F872—A flash-based 8-bit microcontroller manufactured by Microchip.

6—RF switch—A device capable of switching radio frequency signals between different points.

6, 20—SW1001—An RF switch manufactured by Honeywell.

Kissback pulse—A feedback signal created by the alert receiver unit and intended for the reception by the head end alert signal generator/transmitter.

9—DTMF Tone—A standard dual-tone multi-frequency signal as commonly used in telephony.

12—Local control and test computer—A personal computer or similar computer.

7—NOAA weather radio, automatic activation—A device which monitors NOAA broadcasts and automatically sends alert data out a modem port.

213—RF switch cable local antenna—A device which can connect either a cable TV signal or local antenna signal to a tuner input.

23—TDA 9829 tuner—A tuner module manufactured by Philips Semiconductor, Eindhoven, The Netherlands

33—TDQ2549 IF to Video—Device which demodulates a video signal off an intermediate frequency and outputs a baseband video signal.

53—PIC16F872 channel scan and decode—Process based on the PIC16F872 which monitors channels for valid information and subsequently decodes and processes such information.

63—Power Control—Power supply which can switch between AC power and battery power.

233—Low power RF transmitter local family alert—Device which transmits a low power RF signal as a means of indicating an alarm condition.

243—Belt clip receiver—Device which receives the alarm signal from the “Low power RF transmitter local family alert”.

In circuit programming—The ability to reprogram a microcontroller while the microcontroller remains actively engaged in an electronic circuit.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. An alert receiver unit, comprising:
(a) a radio frequency tuner (23) capable of monitoring radio frequency television program video scan signals which replace normal television program video scan signals, on a hard-wired cable network of a cable television system, having a head end, of selected television programming channels;
(b) a microprocessor (53) intersecting said tuner (23), and detecting alert signals on the program video scan signals tuned by said tuner; and
(c) at least one output device, on said alert receiver unit outputting an alert response from said alert receiver unit of a character other than the radio frequency television program channels.

2. An alert receiver unit as in claim 1 wherein said alert receiver unit operates independent of any signal input from, or output to, any television set.

3. An alert receiver unit as in claim 2 wherein said alert receiver is powered separate from any television set, and thus outputs the alert response irrespective of whether any television set, to which said alert receiver unit may be connected, is powered, or turned on.

4. An alert receiver unit as in claim 1, said alert receiver unit further comprising a transmitter, and an input device, which enable a user of said alert receiver unit to transmit a local event to such head of such cable network.

5. A head end signal generator, comprising:
(a) a sync separator (4) receiving a sampling of a radio frequency television program video scan signal of selected television programming channels being distributed through a cable television cable network;
(b) a microprocessor (5) receiving such video scan signals from said sync separator (4);
(c) an auxiliary computer (12) containing a database of recipient addresses and corresponding codes for matching alert signal inputs to codes corresponding to respective such addresses or address groups; and
(d) one or more alert information input sources feeding alert information to said auxiliary computer (12),
said auxiliary computer (12) receiving the alert information, matching the alert information with address information contained in the respective database, and forwarding the address information, along with the alert information, to said microprocessor (5), said microprocessor (5) generating a corresponding alert signal, and placing the alert signal on at least one scan line of the video scan signal received from said sync separator (4), in place of the signal received from sync separator (4) at the respective scan line.

6. A head end signal generator as in claim 5 wherein said auxiliary computer (12) matches the alert signal inputs to addresses in the database according to the type of threat represented by the alert signal.

7. An alert message system, comprising:
(a) a cable network;
(b) a head end at a first source end of said cable network, transmitting regular television programming, including both audio and video scan signals, through the cable network the video scan signals comprising a plurality of video scan lines;
(c) a recipient terminal at a second terminus end of said cable network, said recipient terminal receiving the television programming transmitted from said head end;
(d) a head end alert signal generator generating an alert signal, and placing the alert signal in the video scan on at best one of the video scan lines in the place of a portion of the regular television programming, said head end transmitting the so-modified video scan through the cable network; and
(e) an alert receiver unit proximate said recipient terminal, said alert receiver unit monitoring the video scan signals transmitted by said head end, detecting the alert signal placed in the video scan and outputting an alert response from said alert receiver unit having a character other than the radio frequency television program channels.

8. An alert message system as in claim 7, said alert receiver unit further comprising a transmitter, and an input device, which enable a user of said alert receiver unit to transmit a local event to said head end of said cable network.

9. A television set, comprising:
(a) a receiver receiving radio frequency television program signals, including video scan signals, of selected television programming channels;
(b) a tuner;
(c) a video display which displays a channel selected for viewing;
(d) an audio output which emits audio signal derived from the program signals; and
(e) an alert receiver unit which monitors the video scan signals, and detects non-program alert signals in the video scan and outputs an alert response to one of said audio output, said video display, and an external response device.

10. A method of distributing alert information, comprising:
(a) receiving the alert information at a head end signal generator at a head end of a cable television network, the cable television network transmitting regular television programming, including video scan signals, each comprising a plurality of video scan lines, the cable network having a recipient terminal at a terminus end of the cable network;
(b) generating an alert signal;
(c) placing the alert signal in a video scan, by replacing a portion of the regular television programming on one or more scan lines with the alert signal;
(d) transmitting the so-modified video scan signal into the cable network; and
(e) receiving the so-modified video scan signal at the terminus, and generating a response signal based on the alert signal.

11. A method as in claim 10, including receiving the so-modified video scan signal in an alert receiver unit, outside any television set, and generating a such response signal having a character other than the radio frequency television programming received at said alert receiver unit.

12. A method as in claim 11, including outputting a such response signal, from the alert receiver unit, in the form of one or more of an audible signal, a visible signal, a vibration, and a wireless radio-frequency transmission.

13. A method as in claim 10, the method including transmitting an alert system monitoring signal with each video scan, and thus providing a carrier signal regularly monitoring local event inputs at the terminus at intervals of less than 15 minutes.

14. A method as in claim 10, the method including transmitting a local event signal from a first such terminus to a second such terminus which is not the head end.

15. A method as in claim 10, the alert receiver unit being connected to at least one local sensor receiving local out-of-tolerance conditions, said alert receiver unit comprising a transmitter, and a signal generator capable of generating distinctive signals each representative of the at least one respective local sensor, the method further comprising generating such distinctive signals responsive to such inputs from such local sensors, and transmitting such distinctive signals to the head end.
